(19) United States
(12) Patent Application Publication
(10) Pub. No.: US 2013/0276816 A1
(43) Pub. Date: Oct. 24, 2013

(54) Part of a packaging device

(71) Applicant: Guillaume COUCHE, Paris (FR)

(72) Inventor: Guillaume COUCHE, Paris (FR)

(73) Assignee: L'OREAL, Paris (FR)

(21) Appl. No.: 13/452,405

(22) Filed: Apr. 20, 2012

(51) Int. Cl. A45D 40/26; B32B 5/00; B05D 3/10; B32B 9/04; B05D 1/36; B05D 3/08; C08F 110/06; B32B 15/085

(52) U.S. Cl. 132/317; 526/351; 428/220; 428/461; 428/497; 427/401; 427/322; 427/536

(57) ABSTRACT

A polypropylene part of a device for packaging and/or applying a product, including a body having at least one wall covered, at least partly, with at least one finishing coat, the resilience of said polypropylene being greater than or equal to 7 kJ/m2.

The present invention relates to devices for packaging and/or applying a cosmetic product, and more particularly to the constituent parts of these devices made of polypropylene.

To obtain a visual aspect that is pleasant to eye a consumer's eye, it is known practice to coat certain visible parts of a packaging and/or application device with a finishing coat such as a metal or a lacquer.

Moreover, polypropylene is widely used for making packaging and/or application device parts since it is readily transformable by injection molding, is relatively inexpensive and has advantageous mechanical strength and chemical inertness characteristics.

In-house tests performed have shown that during the assembly of a polypropylene part with other components of the device, or during the use of the device comprising such a part, in the presence of a finishing coat, this coat may be subjected to relatively high mechanical stresses, resulting in its cracking. This crack may be propagated down to the polypropylene body and damage it. The parts that are not coated are not subject to this risk of damage, associated with the presence of the coat and/or with the surface treatment that the part undergoes before the deposition of the coat, such as flaming or a plasma treatment.

There is a need to overcome the above drawback.

### SUMMARY OF THE INVENTION

The invention achieves this by means of a polypropylene part for a device for packaging and/or applying a product, especially a cosmetic product, comprising a body having a wall covered, at least partly, with at least one finishing coat, especially a metal or a lacquer, characterized in that the resilience of the polypropylene is greater than or equal to 7 kJ/m².

The invention makes it possible to conserve the use of polypropylene, which is particularly economical, while at the same time offering the possibility of manufacturing a part of complex shape, for example which has strong curvatures or which may undergo large elastic deformations, in which the stresses to which the part is subjected do not lead to cracking of the finishing coat or of the wall of the body.

The part according to the invention may be a bottle body, a jar body or lid, a pump body, a push-button, a closing cap, a case body or lid or a handling member, this list not being limiting.

The part may be made with at least one click-fastening or screwing relief especially on the wall coated with the finishing coat. The wall may comprise, on the opposite side to the finishing coat, a click-fastening relief such as a circular groove or a circular rim.

Preferably, the resilience of the polypropylene is greater than or equal to 8 kJ/m², better still greater than or equal to 10 or 20 kJ/m² and even better still greater than or equal to 40 kJ/m².

Preferably, the hardness of the polypropylene is less than or equal to 55 and better still less than or equal to 50.

The thickness of the wall intended to be covered, at least partly, with the finishing coat is preferably greater than or equal to 0.5 mm, better still greater than or equal to 0.7 mm, especially greater than or equal to 1 mm, and/or less than or equal to 3 mm, better still less than or equal to 2 mm and more preferably less than or equal to 1.5 mm.

The finishing coat according to the invention may be visible to the user once the part is in place on the device.

To improve the adhesion of the finishing coat to the body of the part to be coated, the part according to the invention may comprise a surface for the finishing coat to grip to. This gripping surface may be defined by a primer deposited on the body of the part, for example by spraying. This gripping surface may also result from the modification of at least one physicochemical property, for example the roughness, of at least a portion of the body of the part before deposition of the finishing coat. The gripping surface may also result from a plasma or flaming treatment.

The invention also relates to a process for preparing a part according to the invention, comprising the following successive steps:
a) manufacture of a body of a polypropylene part according to the invention, for example by injection molding,
b) optionally, treatment of the surface of a wall of the body obtained in step a) by flaming, plasma or deposition of a primer,
c) metallization or lacquering of the wall.

The term “lacquering” should be understood as meaning the deposition of a lacquer or a varnish.

In step a), any standard technique of injection molding of polypropylene known to those skilled in the art may be used.

The metallization may be performed under vacuum or by depositing a metallized lacquer. The lacquering may be performed by dipping or spraying.

The deposition of the finishing coat may involve polymerization or crosslinking under UV or a heat treatment.

The invention also relates to a device for packaging and/or applying a cosmetic product, comprising a part according to the invention and containing a cosmetic product.

The packaging and/or application device according to the invention may be a bottle, a jar, a case, a tube or an applicator. The cosmetic product may be a cream, a gel, a lotion, a loose or compact powder, an oil, a mascara, a lipstick or lip gloss, etc., especially for caring for and/or making up the skin.

The term “resilience” of a material denotes the energy required to break a notched specimen consisting of said material, divided by the area under the notch. The resilience is expressed in kJ/m², and is measured using a “Charpy” impact test at 23° C. The measuring device and the experimental conditions and geometry is of the specimens are described in standard ISO 179.

### DESCRIPTION OF THE FIGURES

The invention may be better understood on reading the following description of non-limiting implementation examples thereof, and with reference to the attached drawing, in which:

FIG. 1 shows in partial longitudinal cross section a part covered with a finishing coat,

FIG. 2 shows in partial longitudinal cross section another implementation example of a part according to the invention.

### DETAILED DESCRIPTION

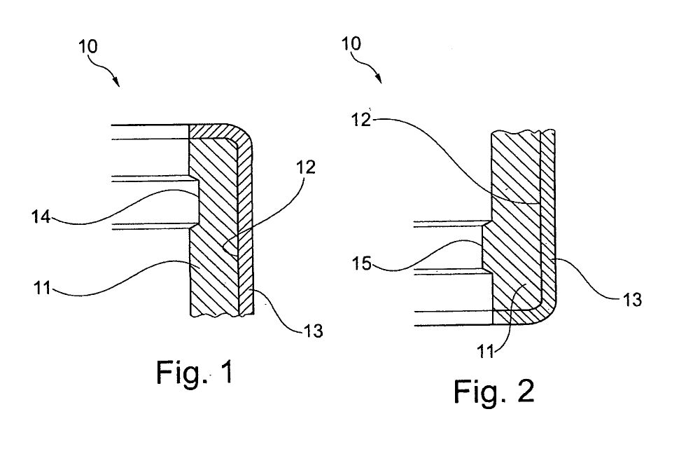

Part 10 according to the invention shown in FIG. 1 comprises a polypropylene body with a resilience of greater than or equal to 7 kJ/m² comprising a wall 11 having a gripping surface 12 covered with a finishing coat 13.

Part 10 comprises, for example, a circular groove 14 for the click-fastening of a relief, not shown, of another portion of the device to which the part belongs.

In the example of FIG. 1, the groove 14 is interior and in the example shown in FIG. 2, part 10 comprises an inner rim 15 arranged to fix into a groove, not shown, of another portion of the device to which the part belongs.

Part 10 of FIG. 1 is, for example, a container body and that of FIG. 2 is a closing stopper.

The gripping surface 12 is obtained, for example, by flaming or plasma treatment, or use of a primer.

### Comparative Tests

The non-limiting examples that follow are given for the purpose of illustrating the invention.

The part is manufactured by injection of polypropylene into a mold. A finishing coat is deposited.

### Comparative Tests

| | | Fire resistance | Young's | Yield | Strain at | | | |
|---|---|---|---|---|---|---|---|---|
| | Commercial | modulus | modulus | strain | failure | | Resilience | Cracking of the |
| Supplier | reference | g/10 min | MPa | % | % | Hardness | kJ/m² | finishing coat |
| Basell | Clyrell EC 140 R | 30 | 850 | 18 | >50 | 28 | 20 | NO |
| Basell | Moplen EP 340M | 7.5 | 1150 | 6 | 50 | 46 | 45 | NO |
| Total | PPC 9712 | 25 | 1150 | 6 | — | 80 | >40 | NO |
| Basell | Moplen EP 240T | 48 | 950 | 5 | >50 | 44 | 8 | NO |
| Basell | Moplen RP 348T | 48 | 1100 | 11 | >50 | 58 | 4.5 | YES |
| Basell | Moplen EP 548S | 48 | 1550 | 5 | >50 | 69 | 4 | YES |

The Young's modulus and the yield strain are measured according to standards ISO 527-1 and ISO 527-2. The hardness is measured according to standards ISO 2039-1 and ISO 2039-2.

In the case where a polypropylene having a resilience according to the invention is used, i.e. greater than or equal to 7 kJ/m², no cracking is observed.

The invention is not limited to a geometry of particular parts, comprising a click-fastening relief on the wall coated with the finishing coat. The expression “comprising a” should be understood as being synonymous with “comprising at least one”.

1. A polypropylene part of a device for packaging and/or applying a product, comprising a body having at least one wall covered, at least partly, with at least one finishing coat, the resilience of said polypropylene being greater than or equal to 7 kJ/m2.

2. The part as claimed in claim 1, the resilience of the polypropylene being greater than or equal to 10 kJ/m2 and better still 20 kJ/m2.

3. The part as claimed in claim 1, the wall having a thickness greater than or equal to 0.5 mm and less than or equal to 3 mm.

4. The part as claimed in claim 1, the finishing coat comprising a varnish, a lacquer or a metal.

5. The part as claimed in claim 1, the wall comprising a click-fastening relief on the opposite side to the finishing coat.

6. The part as claimed in claim 1, the body being obtained by injection molding.

7. The part as claimed in claim 1, the resilience of the polypropylene being greater than or equal to 20 kJ/m2.

8. A process for preparing a part as claimed in claim 1, comprising the following successive steps:
a) manufacture of the body of a polypropylene part,
b) optionally, treatment of the surface of the wall of the body obtained in step a) by flaming or plasma, or deposition of a primer,
c) metallization or lacquering of the wall.

9. A dispensing and/or application device, comprising a part as claimed in claim 1, and a cosmetic product.
